(19) United States
(12) Patent Application Publication
(10) Pub. No.: US 2019/0164246 A1
(43) Pub. Date: May 30, 2019

(54) OVERLAYING SOFTWARE MAPS WITH CRIME RISK FORECAST DATA

(71) Applicant: Promontory Financial Group LLC, Washington, DC (US)

(72) Inventors: Daniel J. Ferranti, Wasington, DC (US); Christopher S. Sidler, Bethesda, MD (US); Sean R. Wareham, McLean, VA (US)

(21) Appl. No.: 15/823,378

(22) Filed: Nov. 27, 2017

(51) Int. Cl. G06Q 50/26; G06F 17/30; G09B 29/00; G06Q 10/04

(52) U.S. Cl. CPC G06Q 50/265; G06Q 10/04; G09B 29/007; G06F 17/30241

(57) ABSTRACT

A method for rendering a crime risk overlay on a software map, the method comprising receiving crime data including a plurality of data elements. Weights are assigned to the plurality of data elements of the crime data based on a correlation to a first crime type. A crime risk rating is determined for the first crime type based on the weighted elements. A crime risk forecast is generated based at least on the crime risk rating and the crime data, the generated crime risk forecast being for a target geographic location, a period of time, and the first crime type. The method further comprises generating a graphical overlay on a map generated by a geographic information system, the graphical overlay visually indicating the target geographic location of the generated crime risk forecast on the map and the generated crime risk rating for the first crime type.

### BACKGROUND

The present invention generally relates to computing devices, and in particular, computing devices and computer-implemented methods for generating crime risk forecasts and conveying the forecasts to a user.

Institutions need to know whether a particular region where they intend to operate carries high business risk. One of the business risks may be a presence of criminal activities in the region and that these criminal activities may necessarily implicate the business transactions conducted by the institutions. Current crime analysis systems provide individuals and business owners with a general idea of whether neighborhoods are relatively safe or unsafe.

However, the current solutions do not identify correlations between certain activities and crimes such as drug trafficking and financial crimes. Accordingly, there is a need for a crime forecasting system and method that enables law enforcement agencies to accurately and effectively deploy resources, and allows business owners to anticipate the risk of crime at a business location.

### SUMMARY

A method, computing systems, and computer program products for rendering a crime risk overlay on a software map are disclosed. According to one embodiment, said method is in a data processing system comprising a processor and a memory. Said method comprising receiving, by said data processing system, crime data from one or more data servers, said crime data including a plurality of data elements. Weights are assigned, by said data processing system, to said plurality of data elements of said crime data based on a correlation to a first crime type. A crime risk rating is determined, by said data processing system, for said first crime type based on said weighted elements. A crime risk forecast is generated, by said data processing system, based at least on said crime risk rating and said crime data, said generated crime risk forecast being for a target geographic location, a period of time, and said first crime type. Said method further comprises generating, by said data processing system, a graphical overlay on a map generated by a geographic information system, said graphical overlay visually indicating said target geographic location of said generated crime risk forecast on said map and said generated crime risk rating for said first crime type.

Said plurality of data elements may include at least one of criminal records, high intensity drug trafficking areas (HIDTA) data, and laws and regulations pertaining to a plurality of crime types. In one embodiment, said computer-implemented method further comprises receiving, by said data processing system, user-specified criteria including said target geographical location, said period of time, and said first crime type. Assigning weights to said plurality of data elements of said crime data may further comprise determining, by said data processing system, said correlation to said first crime type by determining an implication of said first crime type from a presence of a second crime type in said crime data. In another embodiment, determining said crime risk rating for said first crime type further comprises calculating, by said data processing system, a score that is representative of a likelihood of said first crime type occurring within said target geographical location. Determining said crime risk rating for said first crime type may further comprise determining, by said data processing system, a historical volume of a second crime type from said crime data and projecting, by said data processing system, a future volume of said first crime type based on said historical volume of said second crime type. In a further embodiment, said crime risk rating is directly proportional to said projected future volume of said first crime type. Said map may further comprise a heat map and said graphical overlay visually indicates a plurality of colors that correspond to degrees of crime risk based on said generated crime risk rating for said first crime type.

According to one embodiment, said computing system comprises a computer processor and a computer memory operatively coupled to said computer processor. Said computer memory having disposed within it computer program instructions that, when executed by said processor, cause said computing system to carry out the step of receiving crime data from one or more data servers, said crime data including a plurality of data elements. Said processor assigns weights to said plurality of data elements of said crime data based on a correlation to a first crime type. Said processor also determines a crime risk rating for said first crime type based on said weighted elements. Said processor further generates a crime risk forecast based at least on said crime risk rating and said crime data, said generated crime risk forecast being for a target geographic location, a period of time, and said first crime type. Said computing system further comprises said processor generating a graphical overlay on a map generated by a geographic information system, said graphical overlay visually indicating said target geographic location of said generated crime risk forecast on said map and said generated crime risk rating for said first crime type.

Said plurality of data elements may include at least one of criminal records, high intensity drug trafficking areas (HIDTA) data, and laws and regulations pertaining to a plurality of crime types. In one embodiment, said processor receives user-specified criteria including said target geographical location, said period of time, and said first crime type. Assigning weights to said plurality of data elements of said crime data may further comprise said processor determining said correlation to said first crime type by determining an implication of said first crime type from a presence of a second crime type in said crime data. Determining said crime risk rating for said first crime type may further comprise said processor calculating a score that is representative of a likelihood of said first crime type occurring within said target geographical location. In another embodiment, determining said crime risk rating for said first crime type further comprises said processor determining a historical volume of a second crime type from said crime data and projecting a future volume of said first crime type based on said historical volume of said second crime type. In a further embodiment, said crime risk rating is directly proportional to said projected future volume of said first crime type. Said map may comprise a heat map and said graphical overlay visually indicates a plurality of colors that correspond to degrees of crime risk based on said generated crime risk rating for said first crime type.

According to one embodiment, said computer program product comprises a computer readable storage medium having stored thereon program instructions executable by a processing device to cause said processing device to receive crime data from one or more data servers, said crime data including a plurality of data elements. Said computer program product further comprises program instructions executable by said processing device to cause said processing device to assign weights to said plurality of data elements of said crime data based on a correlation to a first crime type. Said computer program product further comprises program instructions executable by said processing device to cause said processing device to determine a crime risk rating for said first crime type based on said weighted elements. Said computer program product also comprises program instructions executable by said processing device to cause said processing device to generate a crime risk forecast based at least on said crime risk rating and said crime data, said generated crime risk forecast being for a target geographic location, a period of time, and said first crime type. Said computer program product further comprises program instructions executable by said processing device to cause said processing device to generate a graphical overlay on a map generated by a geographic information system, said graphical overlay visually indicating said target geographic location of said generated crime risk forecast on said map and said generated crime risk rating for said first crime type.

Said plurality of data elements may include at least one of criminal records, high intensity drug trafficking areas (HIDTA) data, and laws and regulations pertaining to a plurality of crime types. In one embodiment, said instructions executable by said processing device to cause said processing device to assign weights to said plurality of data elements of said crime data further comprises instructions executable by said processing device to cause said processing device to determine said correlation to said first crime type by determining an implication of said first crime type from a presence of a second crime type in said crime data. Said map may comprise a heat map and said graphical overlay visually indicates a plurality of colors that correspond to degrees of crime risk based on said generated crime risk rating for said first crime type.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a logical block diagram of a computing system for forecasting crime risk according to an embodiment of the present invention.

FIG. 4 depicts a flowchart of a method for generating a crime risk forecast according to an embodiment of the present invention.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Exemplary methods, computing systems, and computer program products for forecasting crime risks in accordance with the present invention are described with reference to the accompanying drawings. Based on various inputs such as, criminal records, crime database, and laws and regulations, the presently disclosed system is able to determine the risk scores of certain crimes for a region and display them on a heat map. These inputs are weighted according to a specific type of crime, for example, High Intensity Drug Trafficking Areas (HIDTA) provided by the Drug Enforcement Administration (DEA) may receive a higher weight for a financial crime since the presence of drug trafficking frequently implicates money laundering. Based on the data, the system determines a financial crime risk rating for a particular domestic region (e.g., zip code), and then aggregates the financial crime risk rating for all the regions to generate a heat map for the user. Risk ratings for other types of crimes such as cybertheft, identity theft, etc., may also be determined according to embodiments of the disclosed system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

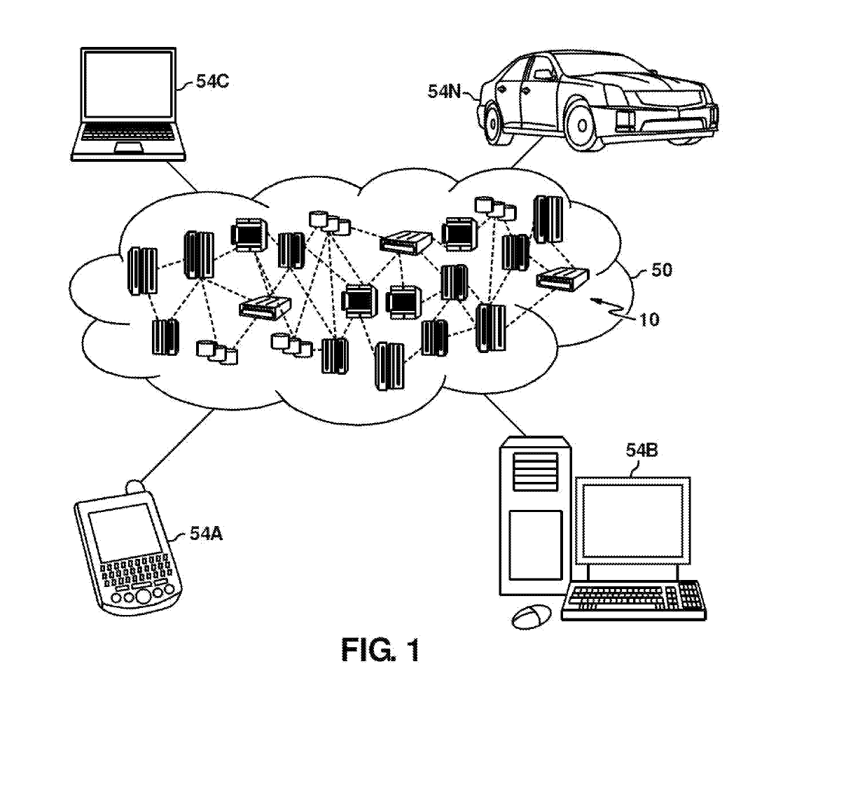

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

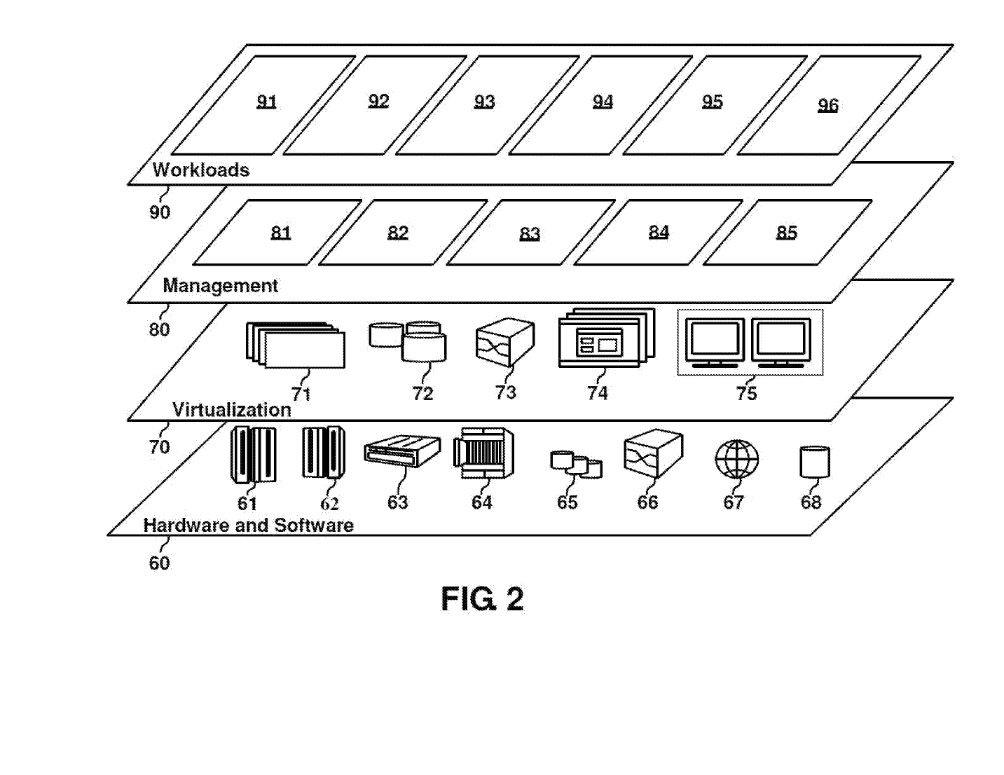

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and forecast processing 96.

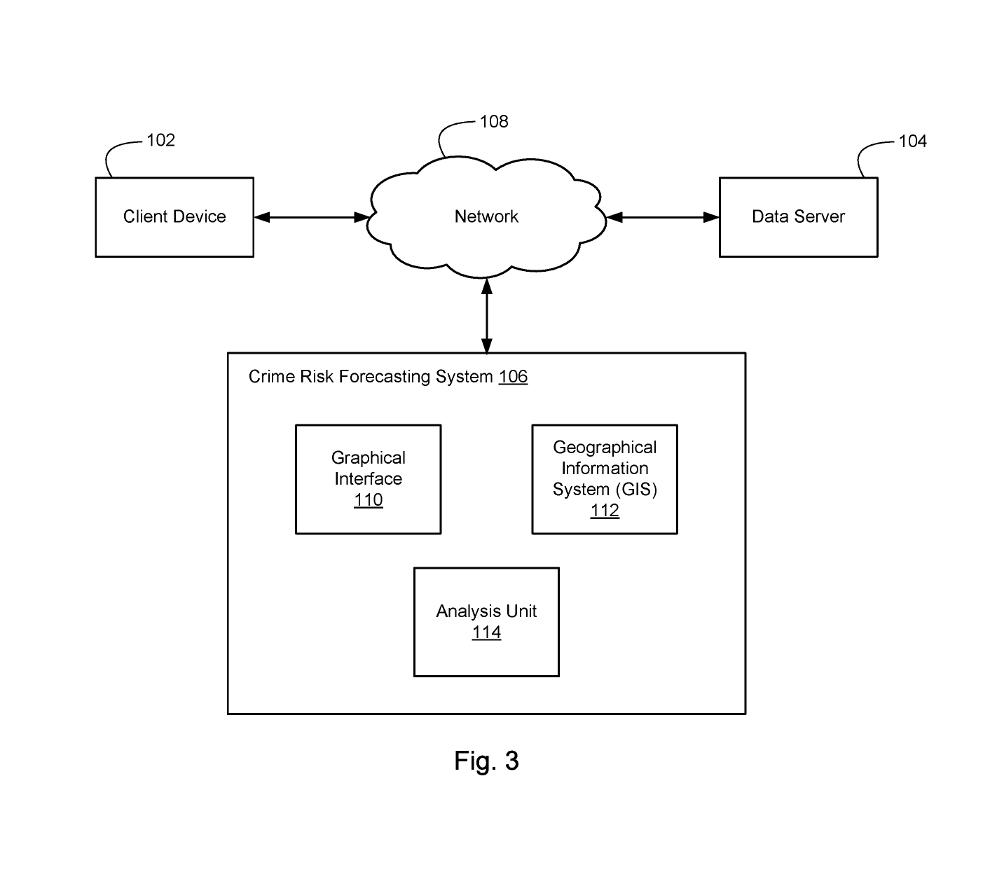

FIG. 3 depicts a logical block diagram of a computing system for forecasting crime risk according to an embodiment of the present invention. The present invention is not limited to the arrangement of servers and other devices in the exemplary system illustrated in FIG. 3, but rather are for explanation. Data processing systems useful according to various embodiments of the present invention may include additional servers, routers, other devices, and peer-to-peer architectures, not shown in FIG. 3, as understood by those of skill in the art.

The system includes a client device 102 and data server 104 communicatively coupled to crime risk forecasting system 106 via a network 108. Client device 102 may comprise computing devices (e.g., desktop computers, terminals, laptops, personal digital assistants (PDA), cellular phones, smartphones, tablet computers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may include or execute a variety of operating systems, such as personal computer operating systems (e.g., Windows, Mac OS or Linux, etc.), mobile operating systems (e.g., iOS, Android, or Windows Mobile, etc.), or the like. A client device may include or may execute a variety of possible applications, such as a client software application enabling communication with other devices, such as communicating one or more messages, such as via email, short message service (SMS), or multimedia message service (MMS).

The system further includes automated computing machinery comprising the crime risk forecasting system 106 useful in crime data processing according to embodiments of the present invention. The system includes at least one computer processor or “CPU” as well as random access memory (“RAM”) which is connected through a high-speed memory bus and bus adapter to the processor and to other components of the server. Stored in RAM, or a hard drive connected to the RAM, may be an analysis unit 114 including computer program instructions that, when executed, cause the computer to perform crime data analysis according to embodiments of the present invention by receiving and extracting crime data from data server 104. The analysis unit 114 may comprise an artificial intelligence unit trained by, e.g., using machine learning techniques such as support vector machines, neural networks, clustering, decision tree learning, etc., to identify associations between certain criminal activities from the crime data.

The crime risk forecasting system 106 may further include a graphical user interface 110 and a geographic information system (GIS) 112. The graphical interface 110 may be any interface that allows a user to input information for transmittal to the crime risk forecasting system 106 and/or any interface that outputs information received from the crime risk forecasting system 106 to a user. The graphical interface 110 may be accessed by software instructions stored on and executed by client device 102. The GIS 112 may be a software system designed to capture, store, manipulate, analyze, manage, and present geographical data. According to one embodiment, the crime risk forecasting system 106 may use third-party GIS software such as Google maps, Environmental Systems Research Institute (Esri), MapInfo, etc.

Data server 104 may comprise one or more computing and storage devices operable to store and provide a source of the crime data from, for example, files, documents, tables, charts, illustrations, photographs, etc. Crime data may comprise criminal records, crime database, and laws and regulations. The crime data may include information indicative of the location, time, date, and type of crime (e.g., assault, burglary, robbery, drugs, etc.). The crime locations may be in a format such that the locations of each crime may be analyzed by the geographical information system (GIS) 112. In some embodiments, the data server 104 also stores location data. The location data may include information such as demographic data, law enforcement boundaries, the locations of buildings such as, police stations, fire stations, schools, churches, hospitals, etc., the locations of businesses, etc. The demographic data may include statistical characteristics of a human population such as, education, nationality, religion, ethnicity, economic, social, cultural, age, and biological factors. For example, data server 104 may comprise a DEA server that provides a map of counties in which HIDTA are designated, which may implicate other types of crimes such as financial crimes.

The crime risk forecasting system 106 may output crime risk forecasts for a plurality of user-identified locations. For example, the graphical interface 110 may plot the crime risk forecasts on a heat map. The graphical interface 110 may enable users to input and specify the crime types and/or a time period for the crime risk forecasts. The analysis unit 114 may calculate the likelihood that one of the user-specified crimes will occur in each of the user-identified location over the user-specified time period and outputs the crime risk forecast for each of the user-identified locations via the graphical interface 110.

The analysis unit 114 may use the GIS 112 to plot the geographic locations and risk of a certain crime based on a determined correlation from the crime data. For example, the analysis unit 114 may determine whether past crimes (or certain types of crimes) are correlated with location data (e.g., neighborhood demographics, law enforcement boundaries, and/or proximity to buildings or businesses). The analysis unit 114 may also determine other potential crimes that are not reflected in the crime data. For example, the analysis unit 114 may determine that crimes (or certain types of crimes) included in the crime data are linearly correlated with another type of crime by a factor of 1.4 (i.e., the other type of crime is 40 percent more likely than normal). Based on such correlations, the analysis unit 114 determines the likelihood of a specific crime occurring at a specific location or in a demographically similar location.

Stored in RAM also is an operating system. Operating systems useful for crime data processing according to embodiments of the present invention include UNIX™ Linux™ Microsoft Windows™ AIX™ IBM's i5/OS™ and others as will occur to those of skill in the art. Non-volatile computer memory also may be implemented for such as an optical disk drive, electrically erasable programmable read-only memory (so-called ‘EEPROM’ or ‘Flash’ memory), RAM drives, and so on, as will occur to those of skill in the art.

Network 108 may be any suitable type of network allowing transport of data communications across thereof. Network 108 may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices and servers may be encrypted using, for example, the Advanced Encryption Standard (AES) with a 128, 192, or 256-bit key size, or any other encryption standard known in the art.

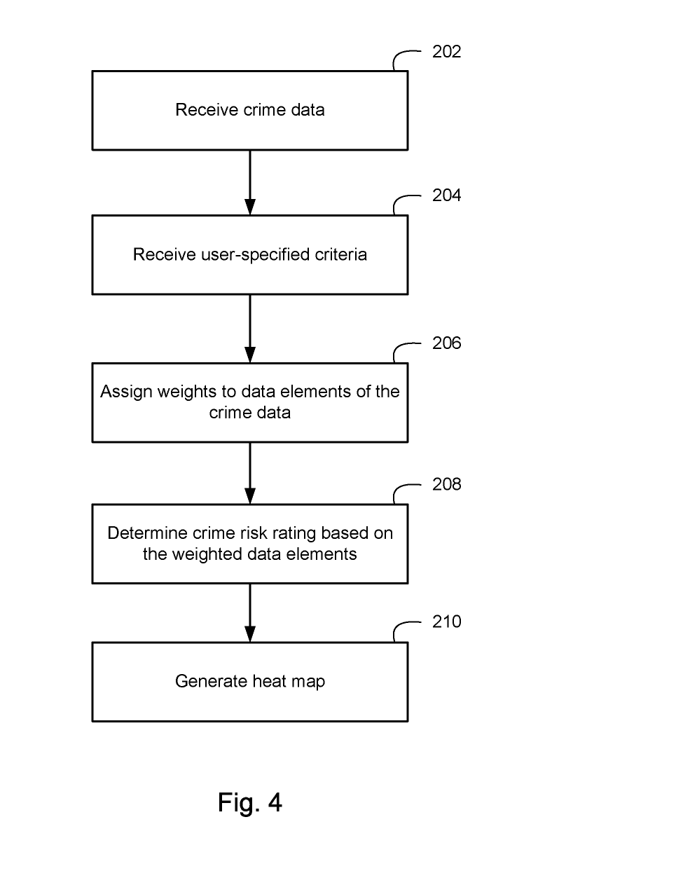

FIG. 4 depicts a flowchart of a method for generating a crime risk forecast according to an embodiment of the present invention. Crime data is received from one or more data sources, step 202. In one embodiment, a crime risk forecasting system receives crime data that contain data elements from data servers, databases, or storage devices. The data elements may include different types of information pertaining to a variety of criminal activities. For example, the data elements may include criminal records, HIDTA data, and local laws and regulations pertaining to certain crimes such as, financial crime. User-specified criteria is received, step 204. The user-specified criteria may include a target geographic location, a period of time, and crime type(s). For example, a user may select a region, city, state, or country that the user desires to analyze and forecast risk for certain types of crimes over a period of time.

Weights are assigned to data elements of the crime data, step 206. The weights may be assigned according to importance of the data elements to the user-specified criteria. Specifically, the data elements may be weighted based on a correlation of the data elements to a selected crime type from the user-specified criteria. A situation may occur where a user selects a crime type that is not wholly reflected in the crime data (e.g., data may not exist to indicate the region in which financial crimes occur). As such, certain data elements of the crime data that are strongly correlated with the selected crime type such as, related crimes, may be assigned a higher weight. For example, HIDTA data may receive a higher weight for forecasting financial crimes from a determination that the presence of drug trafficking frequently implicates money laundering, which is a financial crime.

Crime risk rating is determined based on the weighted data elements, step 208. Determining the crime risk rating may include calculating a score using the weighted data elements to indicate a likelihood of crime according to the user-specified criteria (a selected crime occurring over a selected period of time within a selected target geographic location). Calculating the score may include determining a historical volume of the selected crime (or a crime related to the selected crime) from the crime data and projecting a future volume of the selected crime based on the historical volume. The crime risk rating may be directly proportional to the volume of crime (i.e., the higher the volume the higher the risk rating). Additionally, calculating the score may include determining a historical volume of a first crime type from the crime data and projecting a future volume of a second crime type based on the historical volume of the first crime type. That is, the crime risk forecasting system is able to infer or estimate a volume of other potential crimes (or a type of crime specified by the user) that are not indicated in the crime data by correlating crimes and activities that are likely associated with each other. According to another embodiment, crime volumes and risk ratings may also be projected for other locations based on similar demographics.

A heat map is generated, step 210. The heat map may be a graphical representation that employs a plurality of colors to signify the value of a parameter (e.g., crime density or degree of crime risk) at various points in a spectrum. The heat map may comprise a crime risk forecast to help guide the user to identify regions with higher risks of certain crimes. In one embodiment, the heat map may include a geographical map from GIS software that is overlaid with coloring based on crime risk rating over locations corresponding to, for example, locations on a map in which HIDTA are designated (from the crime data). According to one embodiment, the system may further determine and aggregate crime risk ratings for all or other regions adjacent or in proximity to the selected region. The generated heat map may include the determined crime risk rating for a target location selected according to the user-specified criteria in addition to crime risk ratings of nearby regions or locations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIGS. 1 through 4 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, in a data processing system comprising a processor and a memory, for rendering a crime risk overlay on a software map, the method comprising:
receiving, by the data processing system, crime data from one or more data servers, the crime data including a plurality of data elements;
assigning, by the data processing system, weights to the plurality of data elements of the crime data based on a correlation to a first crime type;
determining, by the data processing system, a crime risk rating for the first crime type based on the weighted elements;
generating, by the data processing system, a crime risk forecast based at least on the crime risk rating and the crime data, the generated crime risk forecast being for a target geographic location, a period of time, and the first crime type; and
generating, by the data processing system, a graphical overlay on a map generated by a geographic information system, the graphical overlay visually indicating the target geographic location of the generated crime risk forecast on the map and the generated crime risk rating for the first crime type.

2. The computer-implemented method of claim 1 wherein the plurality of data elements includes at least one of criminal records, high intensity drug trafficking areas (HIDTA) data, and laws and regulations pertaining to a plurality of crime types.

3. The computer-implemented method of claim 1 further comprising receiving, by the data processing system, user-specified criteria including the target geographical location, the period of time, and the first crime type.

4. The computer-implemented method of claim 1 wherein assigning weights to the plurality of data elements of the crime data further comprises determining, by the data processing system, the correlation to the first crime type by determining an implication of the first crime type from a presence of a second crime type in the crime data.

5. The computer-implemented method of claim 1 wherein determining the crime risk rating for the first crime type further comprises calculating, by the data processing system, a score that is representative of a likelihood of the first crime type occurring within the target geographical location.

6. The computer-implemented method of claim 1 wherein determining the crime risk rating for the first crime type further comprises:
determining, by the data processing system, a historical volume of a second crime type from the crime data; and
projecting, by the data processing system, a future volume of the first crime type based on the historical volume of the second crime type.

7. The computer-implemented method of claim 6 wherein the crime risk rating is directly proportional to the projected future volume of the first crime type.

8. The computer-implemented method of claim 1 wherein the map comprises a heat map and the graphical overlay visually indicates a plurality of colors that correspond to degrees of crime risk based on the generated crime risk rating for the first crime type.

9. A computing system for rendering a crime risk overlay on a software map, the computing system comprising a computer processor and a computer memory operatively coupled to the computer processor, the computer memory having disposed within it computer program instructions that, when executed by the processor, cause the computing system to carry out the steps of:
receiving crime data from one or more data servers, the crime data including a plurality of data elements;
assigning weights to the plurality of data elements of the crime data based on a correlation to a first crime type;
determining a crime risk rating for the first crime type based on the weighted elements;
generating a crime risk forecast based at least on the crime risk rating and the crime data, the generated crime risk forecast being for a target geographic location, a period of time, and the first crime type; and
generating a graphical overlay on a map generated by a geographic information system, the graphical overlay visually indicating the target geographic location of the generated crime risk forecast on the map and the generated crime risk rating for the first crime type.

10. The computing system of claim 9 wherein the plurality of data elements includes at least one of criminal records, high intensity drug trafficking areas (HIDTA) data, and laws and regulations pertaining to a plurality of crime types.

11. The computing system of claim 9 further comprising the processor receiving user-specified criteria including the target geographical location, the period of time, and the first crime type.

12. The computing system of claim 9 wherein assigning weights to the plurality of data elements of the crime data further comprises the processor determining the correlation to the first crime type by determining an implication of the first crime type from a presence of a second crime type in the crime data.

13. The computing system of claim 9 wherein determining the crime risk rating for the first crime type further comprises the processor calculating a score that is representative of a likelihood of the first crime type occurring within the target geographical location.

14. The computing system of claim 9 wherein determining the crime risk rating for the first crime type further comprises the processor:
determining a historical volume of a second crime type from the crime data; and
projecting a future volume of the first crime type based on the historical volume of the second crime type.

15. The computing system of claim 14 wherein the crime risk rating is directly proportional to the projected future volume of the first crime type.

16. The computing system of claim 9 wherein the map comprises a heat map and the graphical overlay visually indicates a plurality of colors that correspond to degrees of crime risk based on the generated crime risk rating for the first crime type.

17. A computer program product for rendering a crime risk overlay on a software map, the computer program product comprising:
a computer readable storage medium having stored thereon:
program instructions executable by a processing device to cause the processing device to receive crime data from one or more data servers, the crime data including a plurality of data elements;
program instructions executable by the processing device to cause the processing device to assign weights to the plurality of data elements of the crime data based on a correlation to a first crime type;
program instructions executable by the processing device to cause the processing device to determine a crime risk rating for the first crime type based on the weighted elements;
program instructions executable by the processing device to cause the processing device to generate a crime risk forecast based at least on the crime risk rating and the crime data, the generated crime risk forecast being for a target geographic location, a period of time, and the first crime type; and
program instructions executable by the processing device to cause the processing device to generate a graphical overlay on a map generated by a geographic information system, the graphical overlay visually indicating the target geographic location of the generated crime risk forecast on the map and the generated crime risk rating for the first crime type.

18. The computer program product of claim 17 wherein the plurality of data elements includes at least one of criminal records, high intensity drug trafficking areas (HIDTA) data, and laws and regulations pertaining to a plurality of crime types.

19. The computer program product of claim 17 wherein the instructions executable by the processing device to cause the processing device to assign weights to the plurality of data elements of the crime data further comprises instructions executable by the processing device to cause the processing device to determine the correlation to the first crime type by determining an implication of the first crime type from a presence of a second crime type in the crime data.

20. The computer program product of claim 17 wherein the map comprises a heat map and the graphical overlay visually indicates a plurality of colors that correspond to degrees of crime risk based on the generated crime risk rating for the first crime type.
